(19) United States
(12) Patent Application Publication
(10) Pub. No.: US 2019/0339671 A1
(43) Pub. Date: Nov. 7, 2019

(54) SYSTEMS AND METHODS FOR AUTOMATIC THREE-DIMENSIONAL OBJECT PRINTING

(71) Applicants: ITAMAR IZHAK YONA, NESS-ZIONA (IL); ABRAHAM ELIEZER YONA, NESS-ZIONA (IL)

(72) Inventors: ITAMAR IZHAK YONA, NESS-ZIONA (IL); ABRAHAM ELIEZER YONA, NESS-ZIONA (IL)

(21) Appl. No.: 16/476,088

(22) PCT Filed: Jan. 4, 2018
(86) PCT No.: PCT/IB2018/050060

§ 371 Date: Jul. 4, 2019

Related U.S. Application Data
(60) Provisional application No. 62/559,576, filed on Sep. 17, 2017.
(60) Provisional application No. 62/442,463, filed on Jan. 5, 2017.

(51) Int. Cl. G05B 19/4099; B33Y 50/02; B29C 64/393

(52) U.S. Cl. CPC G05B 19/4099; B33Y 50/02; G05B 2219/35134; G05B 2219/49007; B29C 64/393

(57) ABSTRACT

A printing system configured to allow automatic additive manufacturing using one-button 3D printing software solution. The system comprises a 3D printing agent providing automated control and accessibility to a 3D printing device, and providing additive manufacturing, and a 3D printing backend providing pre¬ printing logic and workflow allowing automated control of the additive manufacturing solution. The system further includes a machine learning sub-system for object file identification, classification and pattern recognition to make decisions for further 3D object printing providing a one-button 3D printing user experience.

### FIELD OF THE INVENTION

The disclosure herein relates to systems and methods for enabling the analysis and classification of object models for additive manufacturing. In particular, the disclosure relates to three-dimensional printing systems connectable to 3D printing devices and operable to enable an automatic additive manufacturing process of an associated object using one-button 3D printing. Additionally, the disclosure may relate to digital manufacturing tools using CAD files, such as laser cutting machines, machining tools and more.

### BACKGROUND OF THE INVENTION

Three-dimensional (3D) printing, known as additive manufacturing, is a process that creates a physical object from a digital design. 3D printing requires a digital 3D object design file representing an associated object model and this design file may be sliced into thin layers, each layer having a layer height, which is then sent to a 3D printing device for additive manufacturing. As 3D printing, undergoes more mainstream adoption, businesses have used additive manufacturing as part of their development process flow. Whilst the use of additive manufacturing is available, its compatibility to professional printers may require profound knowledge and expertise, printing may be performed only by professional service bureaus. Furthermore, 3D printing is becoming a real alternative to traditional production techniques such as plastic injection.

The worldwide 3D printing industry is expected to grow from $3.07 B in revenue in 2013 to $12.8 B by 2018, and exceed $21 B in worldwide revenue by 2020. As it evolves, 3D printing technology is destined to transform almost every major industry and change the way we live, work, and play in the future (Source: Wohlers Report 2015).

The 3D printing industry encompasses many forms of technologies and materials. For example, in the third quarter of 2017, Materialise, a leading firm in the field of 3D Printing, reported increased revenues for their software, medical and manufacturing divisions. The revenue amounted to a $6 million increase in total when compared to the previous year. This is indicative of those very same increasing applications within the industry, as the field grows larger. Additionally, 3D printing is becoming more and more intertwined with the day-to-day operations of businesses. In terms of outlook, CEOs definitely see 3D printing as a benefit. Most expect a 72% rise in spending for 2018 and 55% expect one in 2017. At this stage, most companies are primarily focusing on research and development (R&D) and prototyping.

Thus, the need remains for providing one-click 3D printing, simplifying the user experience while maintain high quality of additive manufacturing. The invention described herein addresses this need.

### SUMMARY OF THE EMBODIMENTS

According to one aspect of the presently disclosed subject matter, there is a 3D printing system connectable to a 3D printing device operable to analyze a 3D object model represented by at least one object file of an associated object. Analysis may determine a set of parameters and desired configuration and further transmit the object model to the 3D printing device for additive manufacturing. The 3D printing system, comprising: a 3D printing agent operable to provide an automated control and monitoring of accessibility to the 3D printing device to provide an additive manufacturing solution. The system further includes a 3D printing backend operable to provide a pre-printing process workflow and logic to allow the automated control and monitoring of the additive manufacturing solution. The 3D printing system is operable to combine the pre-printing process workflow in an automatic manner, interface with the 3D printing device to enable an additive manufacturing process of the associated object as one button-click printing.

The 3D printing agent may be operable to communicate with the 3D printing backend to send at least one request and receive at least one response. Further, the 3D printing agent is operable to communicate with the 3D printing device configured as a local printer or as a remote printer. Accordingly, the 3D printing agent is operable to control automatically a pre-printing process and generate at least one manufacturing file. The manufacturing file may comprise at least one file of machine language code (G-code) with assigned movements and actions for the 3D printing device.

In some embodiments, the 3D printing backend comprises a machine-learning module comprising a knowledge repository, said machine-learning module operable to update continuously the knowledge repository with data pertaining to the 3D object model.

As appropriate, the at least one object file may be for example an STL (Standard Triangle Language) file, using a set of triangles (polygons) to describe the surfaces of the associated object. Further, the 3D printing agent is operable to send at least one manufacturing file to the 3D printing device for printing. The 3D printing agent may comprise an object file analyzer operable to receive the at least one object file and further to: identify the type of the 3D object model; perform a series of analysis procedures associated with the identified 3D object model; and define associated preferences to identify at least one requirement appropriate for the type of the 3D object model being analyzed.

The object file analyzer may further apply at least one correction to said at least one object file. Optionally, the object file analyzer may further apply an optimization process to said at least one object file. Optionally, the object file analyzer may further determine a desired orientation of the associated object for the additive manufacturing process by selecting an appropriate base plane.

The 3D printing agent may comprise an object file slicer operable to perform stratification of the object model by slicing the object model into a plurality of printable layers, each printable layer spaced a layer height apart. Object files may be represented digitally as a computer aided design (CAD) file, the CAD file includes a file format selected from a group consisting of STL, OBJ, WRL, VRML, 3MF and the like as well as combinations thereof. Object files may comprise data generated by a 3D scanner, or by 3D modeling software. Optionally, object files may include video recordings or sets of captured images at different plane references, possibly generated by a mobile device.

As appropriate, the 3D printing system may include a user interface module operable to provide visualization, automatic and manual control over the 3D printing system by a system user. The 3D printing system may include a chatbot conversational agent operable as a feedback interface for gathering system users' data. The chatbot conversational agent may be operable to update in an ongoing manner the knowledge repository for the machine-learning module and to use ongoing machine learning to identify preferences. The desired orientation may be determined by at least one parameter selected from a group consisting of: a three-dimaional printing device type, manufacturing additive material, object internal forces, surface texture, amount of additive material and combinations thereof, and the knowledge repository of the machine-learning module being updated manually or automatically.

Another aspect of the disclosure is to teach a method for use in a 3D printing system. The system is connectable to a 3D printing device configured for additive manufacturing. The system may analyze a 3D object model represented by at least one object file of an associated object to determine desired configuration parameters and further transmit the object model to the 3D printing device for additive manufacturing using a one button-click printing, in an improved manner. The 3D printing system, comprising: a 3D printing agent operable to provide an automated control and monitoring of accessibility to the at least one 3D printing device and provide an additive manufacturing solution. The system also includes a 3D printing backend operable to provide a pre-printing process logic and workflow to allow the automated control and monitoring of the additive manufacturing solution. The method comprising the steps of; receiving a 3D object model represented in at least one object file of an associated object for additive manufacturing on the 3D printing device, performing object detection analysis using a set of pre-configured system parameters stored in a system data repository, determining a desired orientation for the process additive manufacturing of the associated object, slicing the 3D object model to generate a set of printable layers spaced a layer height apart representing the associated 3D object and directing the set of printable layers to 3D printing device.

The step of performing object detection analysis may comprise: analyzing the 3D object model of the associated object; determining associated preferences to identify at least one requirement appropriate for the type of the 3D object model being analyzed; and applying adjustments to the 3D object model. Further, the step of analyzing the associated object model further comprises: identifying an associated object model; identifying an associated object file configurations; and determining a set of raw data printing parameters. As appropriate, the step of performing object detection analysis further comprising selecting an associated set of printing parameters from the set of raw data printing parameters.

The step of applying adjustments to the 3D object model may comprise: identifying at least one error associated with the at least one 3D printing file; and applying an associated correction to correct the at least one error. Additionally, or alternatively the step of applying adjustments to the 3D object model may comprise: applying an optimization process to the associated object model. Optionally, the set of pre-configured system parameters is retreived from a knowledge repository of a machine learning sub-system. The step of directing the set of printable layers to the 3D printing device may comprise: updating the pre-configured system parameters into said knowledge repository.

### BRIEF DESCRIPTION OF THE FIGURES

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the various selected embodiments may be put into practice. In the accompanying drawings:

FIG. 1A is a schematic block diagram illustrating high level architecture and main elements of one possible 3D printing system, with 3D printing agent communicating with a 3D backend, to enable one click printing a 3D printing device, according to one embodiment of the current disclosure;

FIGS. 1B-C are schematic block diagrams illustrating the main elements of possible 3D networked printing system, with the 3D printing agent communicating over a network with the 3D backend, according to other embodiments of the current disclosure;

FIG. 2A-E is a schematic block diagram illustrating the main elements of a possible 3D printing system for performing a one-click additive manufacturing of an object, according to one embodiment of the current disclosure;

FIG. 3A-B are schematic flowcharts representing examples of methods for performing an automatic pre-printing procedure of an object design file, creating a one-click 3D printing user experience; and

FIGS. 4-6 are schematic flowcharts representing another set of examples methods for performing an automatic pre-printing procedure of an object design file, creating a user experience of a one-click 3D printing.

### DETAILED DESCRIPTION OF THE EMBODIMENT

Aspects of the present disclosure relate to systems and method of providing an interface enabling the classification and analysis of an object model represented by at least one file for additive manufacturing. The disclosure provides a 3D printing system connectable to a 3D printing device and operable to enable an automatic additive manufacturing process using a one-button 3D printing software solution.

Such systems and methods are described in the Applicant's previously filed patent applications U.S. Provisional Patent Application 62/442,463, filed Jan. 5, 2017 and U.S. Provisional Patent Application 62/559,576, filed Sep. 17, 2017, the contents and disclosures of which are incorporated by reference in their entirety and from which priority is claimed.

As required, detailed embodiments of the present invention are disclosed herein; however, it is to be understood that the disclosed embodiments are merely examples of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As appropriate, in various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard disk, flash-drive, removable media or the like, for storing instructions and/or data.

It is particularly noted that the systems and methods of the disclosure herein may not be limited in its application to the details of construction and the arrangement of the components or methods set forth in the description or illustrated in the drawings and examples. The systems and methods of the disclosure may be capable of other embodiments, or of being practiced and carried out in various ways and technologies.

Alternative methods and materials similar or equivalent to those described herein may be used in the practice or testing of embodiments of the disclosure. Nevertheless, particular methods and materials described herein for illustrative purposes only. The materials, methods, and examples not intended to be necessarily limiting. Accordingly, various embodiments may omit, substitute, or add various procedures or components as appropriate. For instance, the methods may be performed in an order different from described, and that various steps may be added, omitted or combined. In addition, aspects and components described with respect to certain embodiments may be combined in various other embodiments.

### General Aspects:

The current common practice of printing an object using a 3D printing device includes creating a 3D object model. The 3D object model may be represented by a digital design file such as a computer aided design (CAD) software, a dedicated 3D modeling software, or generated by a 3D scanner and the like. The creation of a 3D printed object may be achieved using additive processes. In an additive process, an object is created by laying down successive layers of material until the object is created. Each of these layers can be seen as a thinly sliced horizontal cross-section of the eventual object placed at a layer height (known also as the ‘resolution’) apart. Furthermore, the layers may be determined by a ‘slicing’ operation, thus dividing the digital representation of the 3D object model into hundreds or thousands of horizontal layers. When a layered file is uploaded into a 3D printing device, the object is ready to be 3D printed, layer by layer.

It is noted that the process of ‘slicing’ may convert a 3D model into machine language (G-code), to generate a set of printable layers. The ‘layer height’, may use various values, such as 0.02 mm (20 micron) to 0.3 mm (300 micron), as a non limiting example for FFF/FDM. Other resolution ranges may be preferred.

The use of additive manufacturing using professional printers typically requires the extensive knowledge only available via professional service bureaus.

As mentioned above, additive manufacturing service bureaus may provide accessibility to professional machines, tools and productions. There are variety of additive manufacturing solutions, which require dedicated and professional human resources. It is also noted that customers may require service bureaus to provide support and guidance. The professional support given by the service providers may lead to greater engagement and increased transactions.

A feedback interface may be a conversational agent such as a text-based real time agile chatbot agent. The feedback interface may be operable to provide dynamic accessibility to knowledge for customers. Implementation of such a feedback interface may be incorporated into a service provider customer relations working flow. The interface may be operable to facilitate communication with the customers via various platforms such as a Web browser, Text/messenger application, email etc. and the like. Unlike software solutions based on the printing process which fail to solve the main pain for the service providers that need to generate more orders. A real time agile agent may provide accessibility to customers by providing a round the clock customers service center and may further reduce human resources cost, allowing the service provider to focus on production.

Various features of the feedback interface may include: a File upload unit; a file review unit; a CAD analysis unit; a file repair unit; a Quotation simulation generator; and an Artificial Intelligence unit operable for an additive manufacturing environment. Furthermore, the feedback interface agent may be accessed via a web-browser, a smartphone app, a voice activated unit or any other user interface as will occur to those skilled in the art. Accordingly, the feedback interface agent may provide various benefits including: Driving customer's engagement; Accessing to additive manufacturing knowledge; Generating more transactions; Reducing technological human resources costs; Classifying and routing to human assistant when needed; Providing access to a cloud based server. Accordingly, the feedback interface may use smart algorithm which integrates artificial intelligence (Al) and machine learning (ML) into one platform. Accordingly, the algorithm may access an additive manufacturing database as well as flow charts cases to classify customer's requirements. The platform may further identify when to use analysis and repair via several models.

### 3D Printing Technology & Standards:

There are various 3D printing technologies such as Fused Deposition Modelling (FDM) associated with Material Extrusion, Selective Laser Sintering (SLS) associated with Powder Bed Fusion and others. FDM is the most widely used 3D printing technology: it represents the largest installed base of 3D printers globally and is often the first technology people are exposed to. Fused Deposition Modeling (FDM), or Fused Filament Fabrication (FFF), is an additive manufacturing process that belongs to the material extrusion family. In FDM, an object is built by selectively depositing melted material in a pre-determined path layer-by-layer. The materials used are thermoplastic polymers and come in a filament form. The STL (Standard Triangle Language) is the industry standard file type for 3D printing. It uses a series of linked triangles to represent the surfaces' geometry of a solid model. All modern CAD (Computer Aided Design) software, for example, allow to export their native file format into STL (Standard Triangle Language), or other known formats such as OBJ, WRL, VRML and a the new format 3MF. The 3D model is then converted into machine language (G-code) through a process called “slicing” to generate a set of printable layers at a layer height apart (determines the thickness of the slice), thus the file is referred to as ready for printing.

It is noted that All 3D printing, as an additive manufacturing workflow, processes objects layer-by-layer. By increasing the layer height, more triangles may be used, approximating the surfaces of the 3D model better, but also increasing the size of the STL file, for example. It should be appreciated, that due to the additive nature of 3D printing, the thickness of each layer determines the resolution of a print in a similar way that the number of pixels determines the resolution of a television or a computer monitor. Also, lower layer height typically results in objects with smoother surfaces.

### Orientation:

Orientation is the operation of selecting a base plane from which to build an object model and determining the correct orientation is important for quality. Further, it is an important factor in performing an additive manufacturing of a 3D object. It has impact on various printing parameters such as strength, accuracy, surface finish, geometric deformation (warping) and cost. Additionally, it may affect also the level of roundness of holes. For example, orientation affects accuracy, as drawing the 2D ‘image’ per layer is the most accurate part of the whole process. The inaccuracy may apply once the 3rd dimension added, and layers start accumulating on top of one another, then slight deformations from a number of variable may come into play, and may have impact or cause changes to the geometry of the object. These differences may be small, but should be monitored and followed, especially when printing round parts , as the ‘roundness’ will be slightly affected if printed in any other orientation other than vertically.

Additionally, orientation affects surface finish as it affects horizontal curves where the nice smooth surface sliced into ‘steps’. The degree of this ‘stepping’ depends on the gradient of a slope. A steeper slope means smaller steps and a better appearance. Similarly, warping is a major consideration if a part is boxy, has square features and edges and large long flat sections. Warping caused by the thermal difference within an object—heat causes expansion and loss of heat causes contraction.

It is noted that the orientation parameters are essential for a quality additive manufacturing and may change with different printing machine. For example, liquid or extrusion behave differently and requires applying error corrections. Furthermore, reaching the appropriate selection of orientation requires knowing type of 3D printing device, technology, method of operation, material (and density), the function of the object (printing a prototype .vs. a real object, fully functional).

### Machine Learning Process:

As used herein, the term ‘machine learning (ML)’, is any application of artificial intelligence for automating analytical models, such as but not limited to deep learning, data mining, hierarchical learning, supervised learning. The concept of machine learning associated with 3D printing is the application of advanced algorithms against collected data of objects undergoing additive manufacturing to develop assumptions, classifications and decisions for future object printing. Thus, the 3D printing system of the current disclosure supports an ongoing machine learning process and further allows classification of the object models by type. The system classification based upon various parameters such as similarity and identification (partial) of past objects printed, associated with previous additive manufacturing processes.

As appropriate, the internal printing system algorithm identifies patterns and as a result recommend on specific optimization operation, materials, and printing technology parameters. Once automatic decision has been done, the printing system may generate ready to print files, which may be sent to the 3D printing device directly. Additionally, the system algorithm may use additive manufacturing knowledge as well as flow chart cases and object detection to classify objects as well as customers requirements. The 3D printing system is operable to know when to use analysis and repair via several models. Accordingly, the 3D printing needs to apply appropriate technology to perform analysis, optimization, error correction, parameters selection, slicing and more. Thus, the machine learning process is a crucial component directed to increase the efficiency of the 3D printing. Further, the machine learning process based upon an object analyzer module operable to perform object recognition to enable converting an object image in terms of a model, a 2D image, a video session, an object scan and the like, business document into a readable 3D format, such that a final additive process may be obtained efficiently. Human intervention may be necessary, as described hereinabove, to reach a robust and solid printing system and output a desired value function.

The on-going machine learning process may support a dual mode of automatic analysis coupled with manual updates and adjustments. The automatic analysis mode is based upon a knowledge repository continuously accumulating further knowledge that may be applied to new object models uploaded. The manual mode may be combined with the automatic mode as a complementary process in order to improve the automatic analysis mode or may be performed as a stand-alone operation. The machine learning process has a unique advantage of keeping the dual mode (automatic/manual) at changing levels. For example, during the initial phase of operation the manual processing analysis is dominant, requesting more inputs and human intervention. With more data accumulated and betterment of the knowledge repository, the automatic mode becomes more significant, requiring less manual input and corrections. Thus, the machine learning process may depend on human input in a decreasing manner based upon data collection/accumulation and efficiency lead by appropriate classification.

As appropriate, human intervention may be of great importance and essential in cases of reduced clarity, such as handling object models based upon 2D images, video image capturing and the like. Massive usage of the machine learning sub-system enables betterment of the system automation. For example, using a 3D object model file in different angles (manual object detection) allows determining the correct angle based on existing stored parameters, thus reaching the most appropriate orientation. Similarly, using a 2D image and determining the “right” and “wrong” for the algorithmic mechanism, enables to use classification and associate an existing classification to a new image, thus determining the appropriate orientation.

Where appropriate, an ongoing machine learning training process may harvest users' inquiries continuously, using them to generate better and faster algorithms to improve the system's results. Thus, a real time agile chatbot as a feedback interface, as described herein before, may be a conversational agent to provide accessibility to knowledge for system users. The chatbot may gather users' data and may use continuous machine learning to identify preferences. Accordingly, a knowledge repository (a parameter database) may be generated populated by values for printing parameters selected to suit various model types. It is noted that the preliminary set of parameters may be gathered in a number of ways, such as using a chat-bot such as described herein to prompt users to enter preferences manually. Once populated, this knowledge repository may be used by a machine learning method during the automated pre-printing process to generate default values for printing a CAD file of a particular model type, for example.

In parallel, deep learning may be used for the collected data knowledge for learning and researching as a backend processing. Thus, STL data files may be converted into 3D Voxel Index, where Voxel is a 3D pixel, where 3D Voxel file is similar to 3D bitmap file. It may easier to apply Voxel data to deep learning libraries, as deep learning libraries are implemented for image processing based on bitmap (photo) file format.

As appropriate, the machine-learning may add for better optimization processes, regarding various printing parameters: the correct design of materials, checking wall thicknesses and internal wires for sufficient strength, creating escape holes for hollowing the object where and if possible, savings of material and pricing, determine the desired accuracy and shape smoothness and more.

### Chatbot/Feedback Interface:

From a user perspective the feedback interface may be characterized by a frontend chatbot widget/agent. The chatbot widget may be displayed on a provider's website, app or social media agent, where their customers may be able to communicate with it, in the same way they would do with a human representative.

The chatbot may prompt the user to upload a 3D model in some format and continue by asking simple questions in order to understand the customer's needs. This may guide the customer through the ordering process, which leads to a calculated price quote and the placing of an order for printing.

The installation of the chatbot widget may be achieved by adding a single line of code on the providers website that loads the interface agent code for example a piece of JavaScript code.

Alternatively or additionally, the chatbot may gather users' data and use continuous machine learning to identify preferences. The algorithm identifies patterns and as a result recommend on specific optimization operation, materials, and printing technology parameters. Once automatic decision has been done, the platform generates ready to print files which can be sent to the printer directly.

As such the chatbot agent may be installed on the system's user communication device to allow on-going updates to the knowledge repository.

A cloud based server may serve as the system's control center or ‘brain’, executing code directed towards enabling the algorithm described herein. Accordingly, the cloud based server may interact with the customer via the chatbot widget/agent and may further communicate via computer network with databases providing know-how. Thus, the feedback interface's backend may guide the widget on what to ask the customer, analyze and evaluate the model, calculate the price quote, and handle the order.

In various applications, in order to print the model, a user may need to follow an algorithmic or a walk-through manual workflow. Because each step of such algorithms may require software and knowledge, this can result in much lower adoption rates and significant frustration experienced by 3D printer owners and service providers who may experience these common printing process challenges

It is a further feature of the current disclosure to introduce an automated system and method for generating 3D printed models from a user's source file, such as a CAD file or the like.

### Pre-Printing & Pre-Printing Automation:

The pre-printing process is the essential set of procedures required prior to the actual additive manufacturing. Automating this set of procedures may simplify the 3D printing and allow performing such an operation as a one-click operation. Due to the existing complexities, the common practice is to achieve the various procedures using various set of tools and software packages, requiring knowledge, expertise and which are less accessible to home usage and the like.

Typically, a pre-printing process workflow may involve a few key steps each of which has been executed manually using specialized software. These key steps include: 1. Object file analysis—such as identifying the type of model from the file. File may be a CAD file, for example. 2. Defining preferences—identification of requirements appropriate for the type of model being printed. 3. Object file repair and optimization—such as selecting suitable materials for printing the model. 4. Orientation of the model for printing on a 3D printing device,—selecting a base plane from which to build the model. 5. Stratification of the model—slicing a model represented by a file into printable layers.

According to embodiments of the current automated system and method, the pre-printing process workflow is automated such that a user may print any an object file, such as a CAD file, without the need for performing the manual stages of the pre-printing process. For the sake of illustration, in one embodiment, a system user may send a CAD file for printing via a single instruction, such as by clicking on a printing device icon, pressing a keyboard shortcut such as control-p or some other such method. Once the single print instruction has been given, the automated system executes the pre-printing processes, setting all necessary printing parameters without requiring further input from the system user. Thus, unless a system user particularly wants to override the automatic parameters, the system user no prior knowledge of the pre-printing process is necessary for the system user.

Accordingly, further embodiments of the system described herein include a state-of-the-art computerized technology platform enabling an automatic 3D printing process. By integrating artificial intelligence (Al) and machine learning (ML) into one platform a full end-to-end platform can serve to reduce barriers to adoption of 3D printing usage.

A central hub server hosting may be configured and operable to execute a Hub protocol thereby interacting with satellite computing devices associated with printer owners. By coordinating their functions, the central hub and the printer owner units may assist users to print faster using various designs to achieve new peaks in the 3D printing market. These units include, features, including design, materials and printing optimization, object detection and printer troubleshooting, to enable end-to-end 3D printing solutions. It is particularly noted that such a system may allow a single-button initiation of the pre-printing and printing sequence.

A real time agile chatbot provides accessibility to knowledge for users. Communication with the customers may use various platforms (Web browser, Text/messenger application, email etc.). The chatbot uses NLP (Natural Language Processing) and Machine Learning to communicate with the users.

The algorithm uses additive manufacturing knowledge as well as flow chart cases and object detection to classify customer's requirements. The platform knows when to use analysis and repair via several models.

The chatbot gathers users' data and use continuous machine learning to identify preferences. The algorithm identifies patterns and as a result recommend on specific optimization operation, materials, and printing technology parameters. Once automatic decision has been done, the platform generates ready to print files which can be sent to the printer directly.

An ongoing machine learning training process may harvest users' inquiries continuously, using them to generate better and faster algorithms to improve the system's results. Accordingly, a parameter database is generated, populated by values for printing parameters selected to suit various model types and data may be gathered in a number of ways, using a chat-bot, for example, to enter preferences manually. Once populated, the database may be used by a machine learning method during an automated pre-printing process to generate default values for printing a CAD file. Thus, during the automated pre-printing process, the model type may itself be determined automatically. Thus using the method described herein a user may be able to execute three dimensional printing without any previous expertise.

### DESCRIPTION OF THE EMBODIMENTS

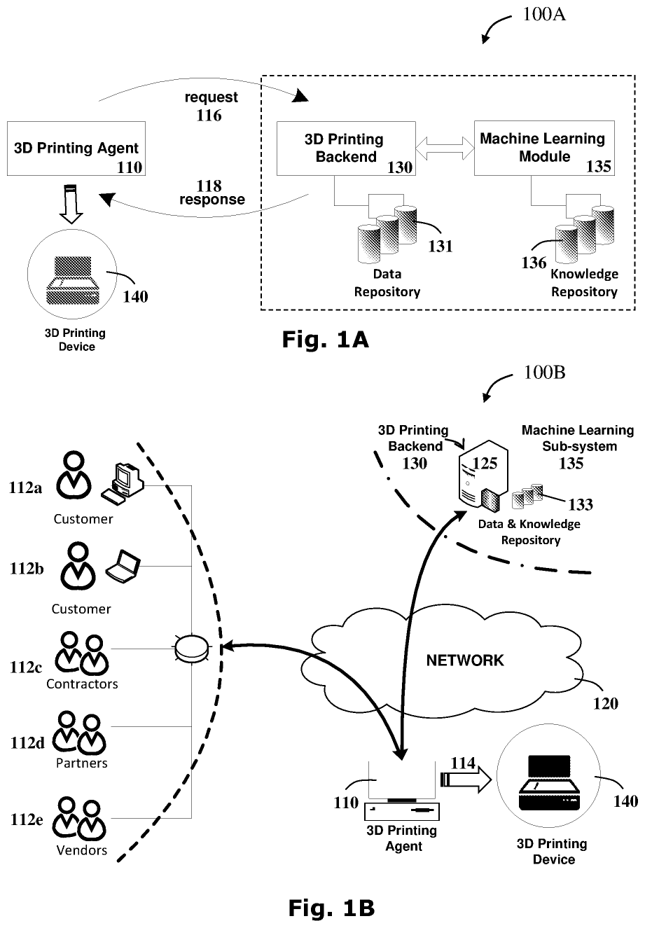

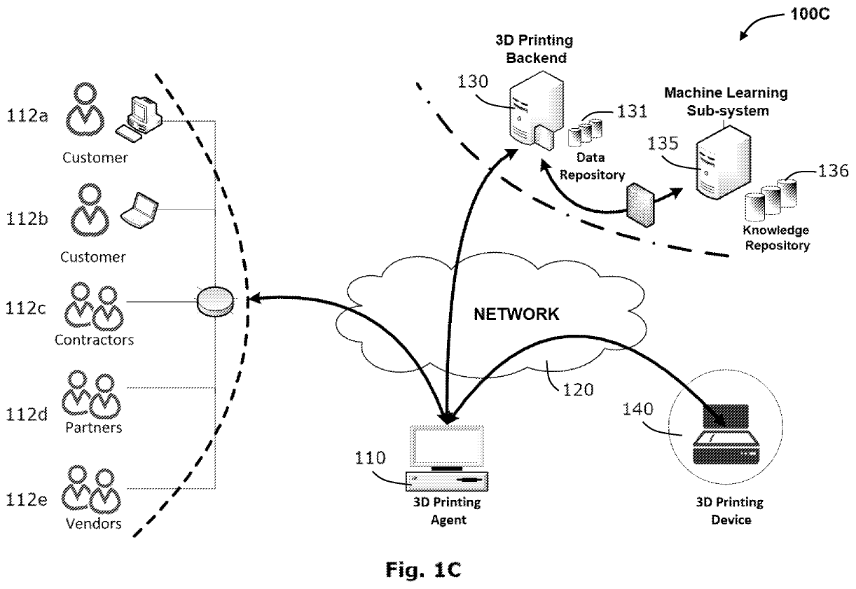

Reference is now made to FIG. 1A, there is provided a general schematic block diagram representing high-level architecture and the main components of a possible 3D printing system, which is generally indicated at 100A, operable to provide object additive manufacturing. The 3D printing system 100A includes a 3D printing agent 110 connectable to a 3D printing device 140 via various network hardware elements (USB cables and the like). The 3D printing system 100A operable to analyze a 3D object model represented by at least one object file, provided by a system user, of an associated object to determine a set of parameters and a desired configuration and further to transmit the object model to the 3D printing device 140 for additive manufacturing.

The 3D printing agent 110 configured to communicate with a 3D printing backend 130, driving the logic and workflow of the additive manufacturing process. The system user may interact with the 3D printing system 100A via the printing agent 110, which in turn sends a request 116 to the printing backend 130 for processing and provide a response 118, accordingly. This logic interaction may then continue, until the loaded object model completes the pre-printing process, as described herein after. Thereafter, the object model may be ready additive manufacturing, thus transmitted to the 3D printing device 140.

It is particularly noted that upon loading the object model onto the 3D printing system 100A, via the 3D printing agent 110, the pre-printing process is fully automatic, thus enabling a one click 3D printing. Further, the 3D printing system 100A represent the main system components being arranged in various system architectures, based upon the system user needs, as detailed herein after.

Reference is now made to FIG. 1B, there is provided a general schematic block diagram representing a possible a networked 3D printing system distribution, which is generally indicated at 100B, providing an indication of the communication path of a system user request to perform additive manufacturing of an object. The 3D printing system 100B may communicate over a network 120 with a 3D printing agent 110 for an automatic pre-printing process and further connect with a 3D printing device 140 for additive manufacturing of a desired object, according to an embodiment of the current disclosure.

Reference is now made to FIG. 10, there is provided a general schematic block diagram representing a possible 3D printing system distribution, which is generally indicated at 100C, providing an indication of the communication path of a system user request to perform additive manufacturing of an object. The 3D printing system 100C may communicate over a network 120 with a 3D printing agent 110 for an automatic pre-printing process and further connect with a 3D printing device 140 for additive manufacturing of a desired object, according to an embodiment of the current disclosure.

Various system users may use the printing system 100C and may be one of a group consisting of: a customer such as 112a and 112b, a contractor 112c, a partner 112d and a vendor 112e. Each time a system user is communicating with the printing system, using his/her own dedicated communicating device, via a network such as a cloud network environment 120 for example, the communication directed towards the 3D printing agent 120, which may further communicate with the 3D printing backend 130, over the network 120.

The 3D printing agent 110 is operable to provide an automated control and monitoring of accessibility to the 3D printing device 140 in order to provide an additive manufacturing solution for an object model represented by at least one object file.

The 3D printing backend 130 operable to provide a pre-printing process workflow and logic to allow the automated control and monitoring of the additive manufacturing solution. The backend 130 may further include a data repository 131 and may further communicate with a machine learning sub-system 135 configured to store the accumulated system knowledge in a knowledge repository 136.

It is noted that the currently presented system distribution 100C is exemplified over the network. One should appreciate that other configurations may exist, such as having the 3D printing agent 120 and the 3D printing backend 130 installed on home/office desktop machine, with the machine learning sub-system 135 over the network, and the like.

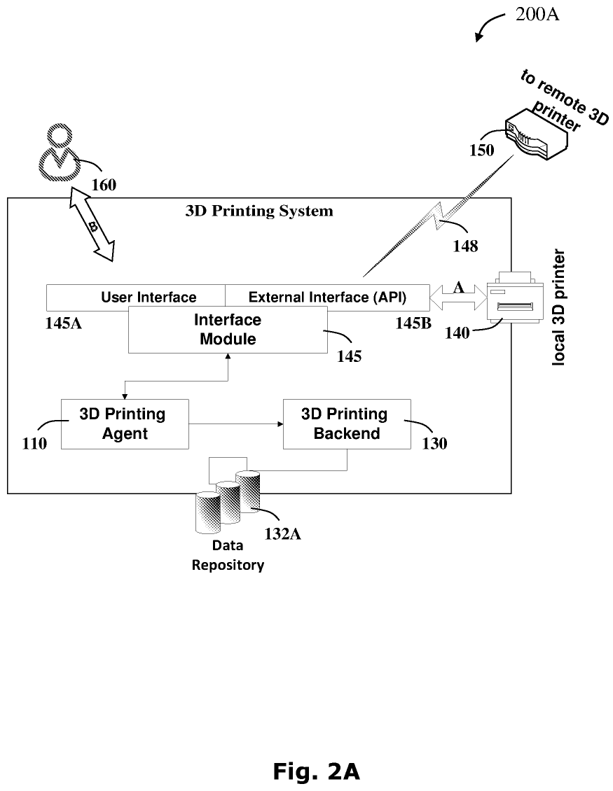

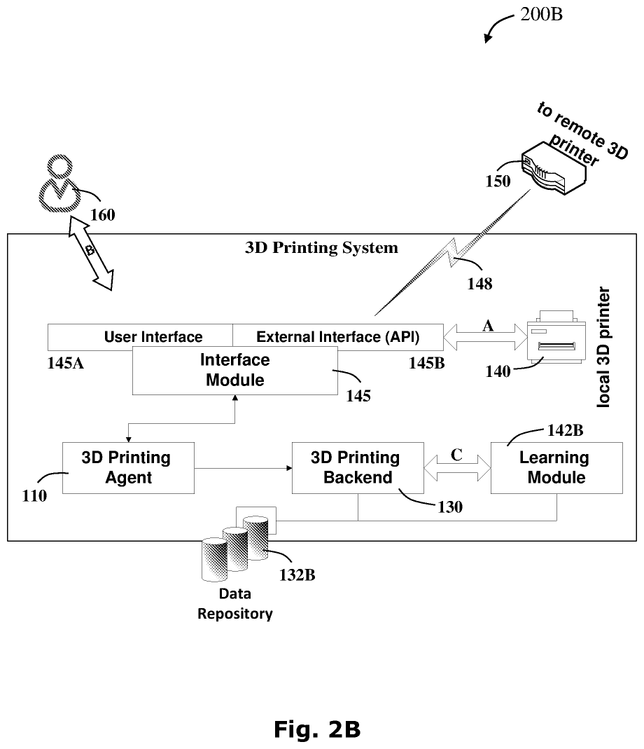

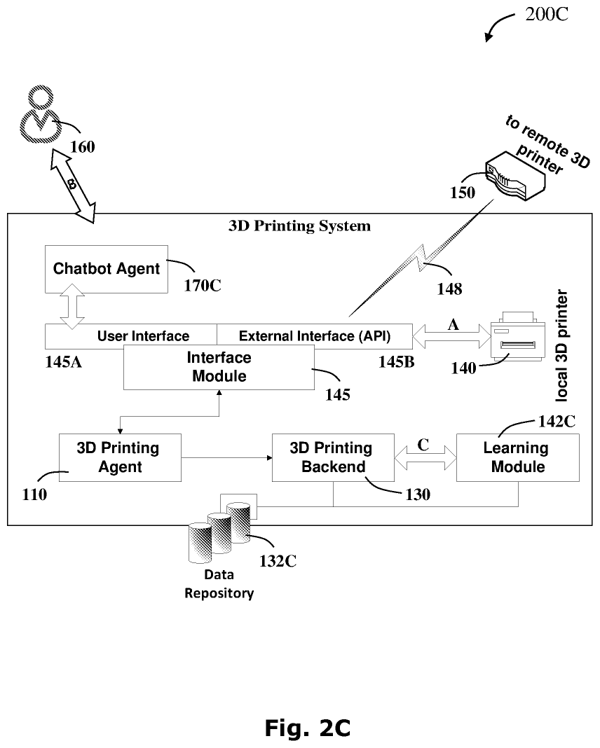

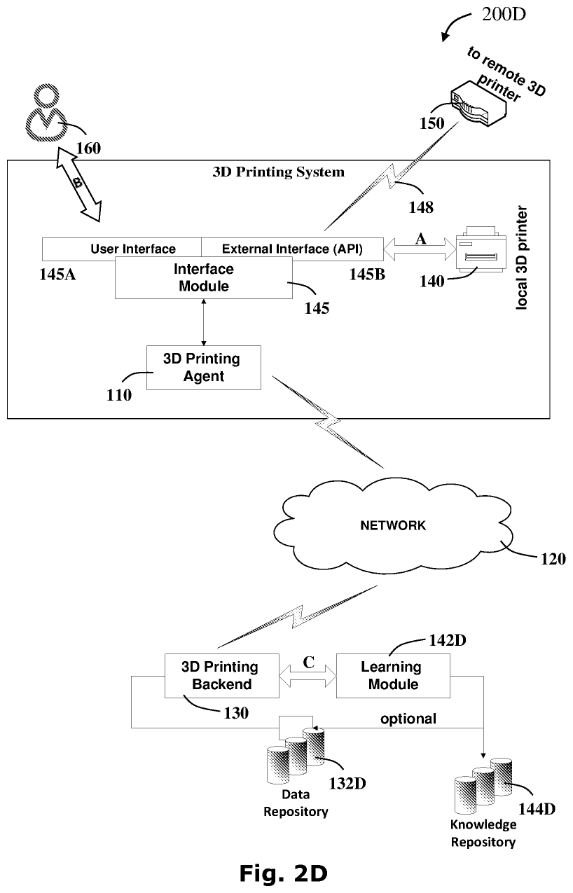

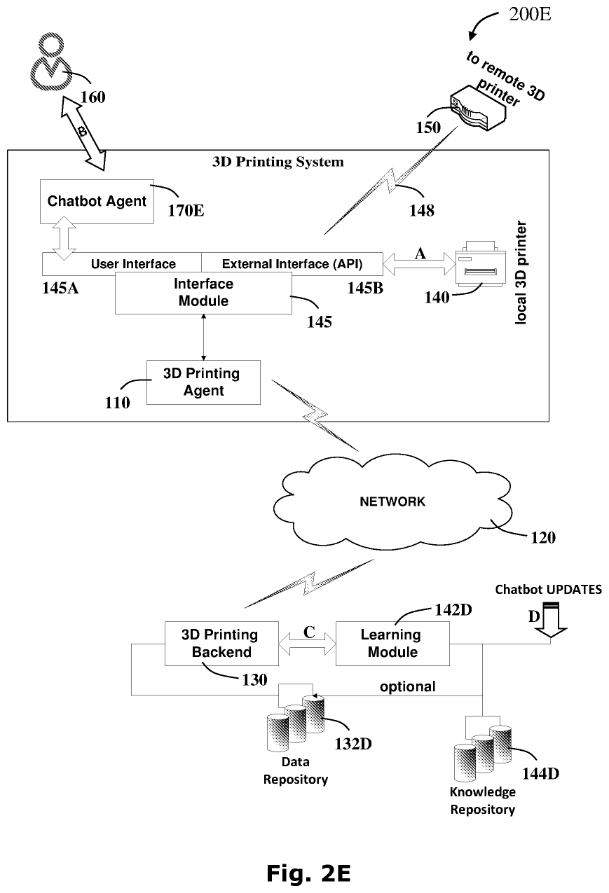

Reference is now made to FIG. 2A, there is provided a general schematic block diagram of the main elements of an integrated automated 3D printing system, which is generally indicated at 200A, for performing a one click additive manufacturing of an object, according to one embodiment of the current disclosure. The 3D printing system 200A consists of a 3D printing agent 110 accessible via an interface module 145 and communicating with a 3D printing backend 130 connectable to a data repository 132A.

The 3D printing agent 110 directed to control the 3D printing system 200 components and further operable to communicate externally via the interface module 145 comprising a user interface 145A to allow a system user 160 to interact with the 3D printing system 200A through channel B. The interface module 145 further includes an external interface 145B allowing connecting with a local 3D printing device 140 via channel A and with a remote 3D printing device 150 via a communication channel 148.

Reference is now made to FIG. 2B, there is provided another general schematic block diagram of the main elements of an integrated automated 3D printing system, which is generally indicated at 200B, for performing a one click additive manufacturing of an object, according to another embodiment of the current disclosure. The 3D printing system 200B further includes a learning module using advanced algorithms to analyze previously gathered data of objects printed to improve the additive manufacturing, develop assumptions, classifications and apply decisions for future object printing. It is noted that the learning module may use the data repository 132B of the printing system to store related knowledge information or may use a dedicated knowledge repository (not shown).

Reference is now made to FIG. 2C, there is provided yet another general schematic block diagram of the main elements of an integrated automated 3D printing system, which is generally indicated at 200C, for performing a one click additive manufacturing of an object, according to yet another embodiment of the current disclosure. The 3D printing system 200C further includes a real time chatbot 170C. The real time chatbot agent 170C provides accessibility to knowledge for system users, gathers users' data to update the machine-learning module 142C.

Reference is now made to FIG. 2D, there is provided a general schematic block diagram of the main elements of a networked automated 3D printing system, which is generally indicated at 200D, for performing a one click additive manufacturing of an object, according to one embodiment of the current disclosure. The 3D printing system 200D consists of a 3D printing agent 110 accessible via an interface module 145 and communicating with a 3D printing backend 130 via a network 120. The backend is further connectable to a learning module 142D configured to use advanced algorithms to analyze previously gathered data of printed objects, improve the internal analysis algorithm, identify patterns and as a result recommend on specific optimization operation, materials, and printing technology parameters. The data of the 3D printing backend 130 is stored in a data repository 132D, and associated knowledge information of the learning module is stored in a knowledge repository 144D. Optionally, the data repository 132D and the knowledge repository 144D may share a single data repository.

Reference is now made to FIG. 2E, there is provided a general schematic block diagram of the main elements of another networked automated 3D printing system, which is generally indicated at 200E, for performing a one click additive manufacturing of an object, according to another embodiment of the current disclosure. The knowledge repository 144D may receive chatbot updates from the real time chatbot agent 170E, operable to provide accessibility to knowledge for system users, gathers users' data to update the machine-learning module 144D.

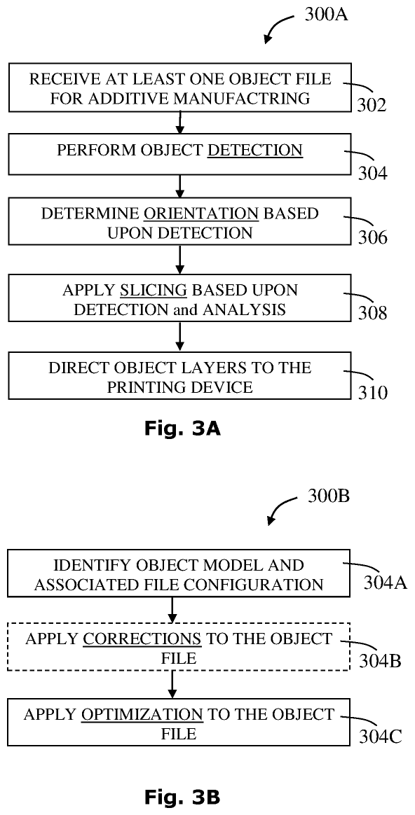

Reference is now made to FIG. 3A, there is provided a flowchart representing selected actions illustrating a possible method configured for use in a 3D printing system, which is generally indicated at 300A, for automating the pre-printing process, once the object design file being received. The method 300A covers one exemplified business usage enabling an automatic pre-printing workflow and further to perform an additive manufacturing process on 3D printing device, creating a user experience of a one click 3D printing. The method 300A may be triggered by a system user, executing a software application installed on his/her communication device such as a personal computer, a laptop computer, a tablet, a portable device, a mobile device and the like, and includes the following steps: step 302—receiving at least one object design file for additive manufacturing on a 3D printing device (such as FIGS. 2A-E, item 140 or 150); step 304—performing an object detection process, including identification, correction and optimization, as described herein after in FIG. 3B; step 306—determining the desired orientation of the object for the additive manufacturing process, such that associated appropriate base plane being selected for the object targeted for the additive manufacturing process; step 308—applying a slicing process based upon the outcome and analysis of the object detection step; and step 310—directing the object layers at a layer height apart, as described by the G-code machine language and upon converting the STL file to G-code. The file format of G-code format used to enable 3D printing, and determines the coordinates upon the slicing procedure and allows controlling the movements of the 3D printing device.

Reference is now made to FIG. 3B, there is provided a flowchart representing selected actions illustrating a possible method configured for use in a 3D printing system, which is generally indicated at 300B, for performing object detection during the pre-printing process. The method 300B may be triggered during the workflow of the pre-printing process as detailed by method 300A (step 304), and includes the following steps: step 304A—identifying the associated object model, performing initial file analysis to determine relevant file configurations, as reflected from the object file; step 304B—optionally, applying corrections to the at least one object design file designated for additive manufacturing on a 3D printing device. It should be appreciated that corrections may be applied using the machine learning sub-system (FIGS. 1A-C, item 135) and data accumulated in the knowledge repository (FIGS. 1A-C, item 136); and step 304C—applying an optimization process to the object file, aims at improving the model as part of the process of preparing the object model for printing. Improvements may vary according to design and needs. The system may apply an hollowing process, for example, to reduce amount of material, apply better orientation, add internal support, material selection, internal configuration to improve surface finish, accuracy and the like.

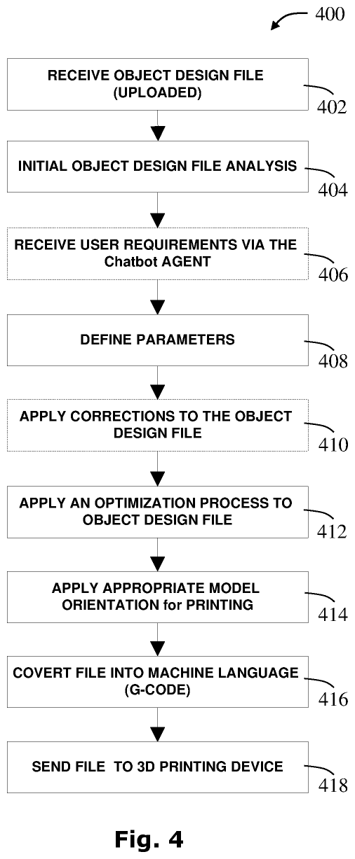

Reference is now made to FIG. 4, there is provided a flowchart representing selected actions illustrating a possible method configured for use in a 3D printing system, which is generally indicated at 400, for automating the pre-printing process. The method 400 covers an exemplified business usage of controlling and managing an automatic pre-printing workflow to perform an additive manufacturing process on a 3D printing device by a system user, thus enabling a one click 3D printing. The method 400 may be triggered by a system user, executing a software application loaded and installed on a communication device such as a personal computer, a laptop computer, a tablet, a portable device, a mobile device and the like, and includes the following steps: step 402—receiving at least one object design file representing an object model for printing on a 3D printing device, possibly uploaded. The object file may be a product of a computer aided design (CAD) system, an object file comprising data generated by a 3D scanner, a video session capturing around the object, a set of 2D photographs of the object from different angles (top, bottom, sides and more); step 404—performing initial analysis of the received object design file to validate correctness of the file; step 406—optionally, receiving a set of system user requirements via the chatbot agent to allow better system configuration to answer the additive manufacturing requirements; step 408—defining parameters; step 410—optionally, applying correction to the object design file received; step 412—applying an optimization process to the object design file; step 414—applying appropriate orientation for the designed object based upon the desired configuration to reach the desired accuracy, surface finish, minimized warping and at a reduced cost; step 416—converting the object design file into machine language (G-code). With 3D printing, G-code contains commands to move parts within the printer. G-code consists of G- and M-commands that have an assigned movement or action. Most G-code automatically generated by a slicing program, converting an STL file into a G-code file. It should be appreciated that there are hundreds or thousands of movements involved in producing a 3D print, thus the G-code may turn in files of large size; and step 418—sending the converted object design file to a 3D printing device, for additive manufacturing.

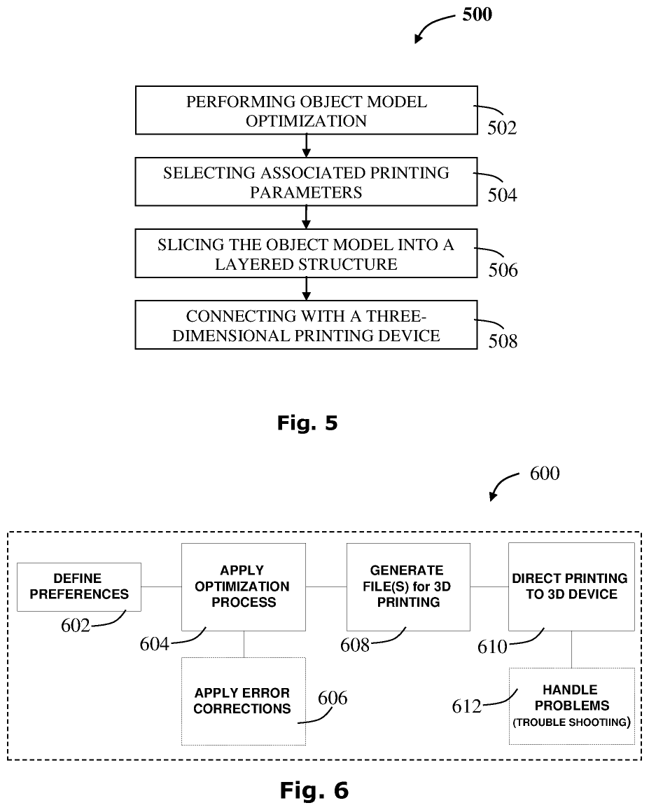

Reference is now made to FIG. 5, there is provided a flowchart representing selected actions illustrating a possible method configured for use in a 3D printing system, which is generally indicated at 500, for automating the pre-printing process, assuming the object file received is ready for analysis, converted into an STL object file, for example. The method 500 covers another exemplified business usage, enabling an automatic pre-printing workflow for a designated object file, thereafter connecting with the 3D printing device and further perform the additive manufacturing process, creating a user experience of a one click 3D printing. The method 500 may be triggered by a system user, executing a software application installed on a communication device such as a personal computer, a laptop computer, a tablet, a portable device, a mobile device and the like, and includes the following steps: step 502—performing object model optimization, variously identify patterns and recommend on specific optimization operation, materials, and printing technology parameters; step 504—selecting associated printing parameters for the actual additive manufacturing process; step 506—applying a slicing process based upon the outcome and analysis of the object model optimization step, generating object layers at a layer height apart, as described by the G-code machine language and upon converting the STL file to G-code; and step 508—connecting with the 3D printing device in order to direct the G-code file format to the printing device. It is noted that the G-code machine language determines the coordinates upon the slicing procedure and allows controlling the movements of the 3D printing device.

Reference is now made to FIG. 6, there is provided a flowchart representing selected actions illustrating another possible method configured for use in a 3D printing system, which is generally indicated at 600, for automating the pre-printing process, assuming an object file received. The method 600 covers another exemplified business usage, enabling an automatic pre-printing workflow for a designated object file, thereafter connecting with the 3D printing device and directing the associated converted files to the 3D printing device to perform the additive manufacturing process, creating a user experience of a one click 3D printing. The method 600 may be triggered by a system user, executing a software application installed on a communication device, as detailed above, and includes the following steps: step 602—defining the desired preferences based upon object file analysis while identifying internal patterns; step 604—performing object model optimization and variously, recommending on specific optimization operation, materials, and printing technology parameters and further selecting associated printing parameters for the actual additive manufacturing process, optionally step 606—apply error corrections, if applicable; step 608—generating the associated files for printing, commonly by applying a slicing process based upon the outcome and analysis of the object model optimization step, generating object layers at a layer height apart, as described by the G-code machine language and upon converting the STL file to G-code; and step 610—directing the output (pre-generated file) to the 3D printing device, after connecting with the device. The output file directed to the printing device may be a G-code files format for the printing device, optionally in step 612—handling and troubleshooting problems during the process additive manufacturing.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like intended to include all such new technologies a priori. As used herein the term “about” refers to at least ±10%. The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”. The phrase “consisting essentially of” means that the composition or method may include additional ingredients and/or steps, but only if the additional ingredients and/or steps do not materially alter the basic and novel characteristics of the claimed composition or method. As used herein, the singular form “a”, “an” and “the” may include plural references unless the context clearly dictates otherwise. For example, the term “a compound” or “at least one compound” may include a plurality of compounds, including mixtures thereof. The word “exemplary” is used herein to mean “serving as an example, instance or illustration”. Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6, should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the invention, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the invention has been described in conjunction with specific embodiments thereof, it is evident that other alternatives, modifications, variations and equivalents will be apparent to those skilled in the art. Accordingly, it is intended to embrace all such alternatives, modifications, variations and equivalents that fall within the spirit of the invention and the broad scope of the appended claims. Additionally, the various embodiments set forth hereinabove are described in terms of exemplary block diagrams, flow charts and other illustrations. As will be apparent to those of ordinary skill in the art, the illustrated embodiments and their various alternatives may be implemented without confinement to the illustrated examples. For example, a block diagram and the accompanying description should not be construed as mandating a particular architecture, layout or configuration. The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations. Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting. The scope of the disclosed subject matter is defined by the appended claims and includes both combinations and sub combinations of the various features described hereinabove as well as variations and modifications thereof, which would occur to persons skilled in the art upon reading the foregoing description.

1-32. (canceled)

33. A 3D printing system connectable to a 3D printing device operable to analyze a 3D object model represented by at least one object file of an associated object to determine a set of parameters and a desired configuration and further to transmit the object model to the 3D printing device for additive manufacturing, said 3D printing system, comprising:
a 3D printing agent operable to provide automated control and monitoring of accessibility to said 3D printing device to provide an additive manufacturing solution by automatically controlling a pre-printing process and generating at least one manufacturing file, said 3D printing agent comprising:
an object file slicer operable to perform stratification of the object model by slicing the object model into a plurality of printable layers, each said printable layer placed at a layer height apart; and
an object file analyzer operable to:
receive the at least one object file;
identify the type of the 3D object model;
perform a series of analysis procedures associated with the identified 3D object model;
define associated preferences to identify at least one requirement appropriate for the type of the 3D object model being analyzed; and
determine a desired orientation of the associated object for the additive manufacturing process by selecting an appropriate base plane.
a 3D printing backend operable to provide a pre-printing process workflow and logic to allow the automated control and monitoring of said additive manufacturing solution, said 3D printing backend comprising a machine-learning module comprising a knowledge repository, said machine-learning module operable to update continuously the knowledge repository with data pertaining to said 3D object model;
wherein said 3D printing system is operable to:
combine the pre-printing process workflow in an automatic manner, and
interface with the 3D printing device to enable an additive manufacturing process of the associated object as a one-button 3D printing software solution.

34. The 3D printing system of claim 33, wherein said 3D printing agent is operable to communicate with the 3D printing backend to send at least one request and receive at least one response.

35. The 3D printing system of claim 33, wherein said 3D printing agent is operable to communicate with the 3D printing device configured as a local printer or as a remote printer.

36. The 3D printing system of claim 35, wherein said at least one manufacturing file comprising at least one file of machine language code (G-code) with assigned movements and actions for said 3D printing device.

37. The 3D printing system of claim 33, wherein said at least one object file is an STL (Standard Triangle Language) file, said STL file uses a set of triangles (polygons) to describe the surfaces of said associated object.

38. The 3D printing system of claim 35, wherein said 3D printing agent is further operable to send the at least one manufacturing file to the 3D printing device for additive manufacturing.

39. The 3D printing system of claim 33, wherein said object file analyzer is further operable to apply at least one correction to said at least one object file.

40. The 3D printing system of claim 33, wherein said object file analyzer is further operable to apply an optimization process to said at least one object file.

41. The 3D printing system of claim 33, wherein said at least one object file is represented digitally as a computer aided design (CAD) file, said CAD file includes a file format selected from a group consisting of STL, OBJ, WRL, VRML, 3MF.

42. The 3D printing system of claim 33, wherein said at least one object file comprises data generated by at least one of a 3D scanner, a three-dimension modeling software, a video recording, and a set of captured images at different plane references.

43. The 3D printing system of claim 33, further comprising a user interface module operable to provide visualization, automatic and manual control over said 3D printing system by a system user.

44. The 3D printing system of claim 33, further comprising a chatbot conversational agent operable as a feedback interface for gathering system users' data.

45. The 3D printing system of claim 44, wherein said chatbot conversational agent is further operable to update in an ongoing manner the knowledge repository of the machine-learning module and use ongoing machine learning to identify preferences.

46. The 3D printing system of claim 45, wherein the knowledge repository of the machine-learning module being updated manually or automatically.

47. The 3D printing system of claim 33, wherein said desired orientation is determined by at least one parameter selected from a group consisting of: a 3D printing device type, manufacturing additive material, object internal forces, surface texture, amount of additive material and combinations thereof.

48. A method for use in a 3D printing system, connectable to a 3D printing device configured for additive manufacturing, said system operable to analyze a 3D object model represented by at least one object file of an associated object to determine a desired configuration parameters and further transmit the object model to the 3D printing device for additive manufacturing using a one-button 3D printing software solution, in an improved manner, said 3D printing system, comprising:
a 3D printing agent operable to provide an automated control and monitoring of accessibility to said at least one 3D printing device and provide an additive manufacturing solution; and
a 3D printing backend operable to provide a pre-printing process logic and workflow to allow the automated control and monitoring of said additive manufacturing solution, said method comprising the steps of:
receiving a 3D object model represented in at least one object file of an associated object for additive manufacturing on said 3D printing device;
performing object detection analysis using a set of pre-configured system parameters retreived from a knowledge repository of a machine learning sub-system and stored in a system data repository;
analyzing the 3D object model of the associated object by:
identifying an associated object model;
identifying an associated object file configurations; and
determining a set of raw data printing parameters;
determine associated preferences to identify at least one requirement appropriate for the type of the 3D object model being analyzed; and
applying adjustments to the 3D object model.
determining a desired orientation for the process additive manufacturing of the associated object;
slicing said 3D object model to generate a set of printable layers at a layer height apart representing the associated object; and
directing the set of printable layers to 3D printing device.

49. The method of claim 48, wherein the step of performing object detection analysis further comprising selecting an associated set of printing parameters from the set of raw data printing parameters.

50. The method of claim 48, wherein the step of applying adjustments to the 3D object model further comprising:
identifying at least one error associated with the at least one 3D printing file; and
applying an associated correction to correct the at least one error.

51. The method of claim 48, wherein the step of applying adjustments to the 3D object model further comprising: applying an optimization process to the associated object model.

52. The method of claim 48, wherein the step of directing the set of printable layers to the 3D printing device further comprising: updating the pre-configured system parameters into said knowledge repository.
